(19) United States
(12) Patent Application Publication
(10) Pub. No.: US 2026/0186968 A1
(43) Pub. Date: Jul. 2, 2026

(54) DEVICE AND METHOD FOR NON-BLOCKING MISS HANDLING AND REPLACEMENT IN PAGE-TABLE-BASED DRAM CACHE

(71) Applicant: UIF (University Industry Foundation), Yonsei University, Seoul (KR)

(72) Inventors: William Jinho Song, Seoul (KR); Youngin Kim, Seoul (KR)

(21) Appl. No.: 19/433,660

(22) Filed: Dec. 26, 2025

(30) Foreign Application Priority Data
Dec. 30, 2024 (KR) 10-2024-0200393

(51) Int. Cl. G06F 12/0802

(52) U.S. Cl. CPC G06F 12/0802; G06F 2212/60

(57) ABSTRACT

The present disclosure relates to a DRAM cache management device. The DRAM cache management device includes: a processor; a main memory; a DRAM cache memory; a DRAM cache management unit connected to one or more cache frames that partition the DRAM cache memory; and a memory management unit configured to generate cache-miss information and transmit the generated cache-miss information to the DRAM cache management unit, wherein the DRAM cache management unit may be configured to receive the cache-miss information from the memory management unit, allocate a free cache frame from among the one or more cache frames upon receiving the cache-miss information, generate a data replication command, and update cache-main memory mapping information between the DRAM cache frames and one or more main memory frames that partition the main memory.

### CROSS-REFERENCE TO RELATED PATENT APPLICATION

This application claims priority under 35 U.S.C. § 119 to Korean Patent Application No. 10-2024-0200393, filed in the Korean Intellectual Property Office on Dec. 30, 2024, the entire contents of which are hereby incorporated by reference.

### TECHNICAL FIELD

The present disclosure relates to a method and device for effective management of a DRAM cache, and more particularly, to a device for non-blocking miss handling and replacement.

### BACKGROUND

With the recent increase in applications requiring a high-capacity, high-bandwidth memory, a method of simultaneously employing heterogeneous packages consisting of a high-bandwidth on-package DRAM and off-package memory has begun to emerge.

One of the approaches to effectively using a heterogeneous memory system is to employ an on-package DRAM as a cache memory. Methods for using the on-package DRAM as the cache memory is broadly classified into hardware-based techniques and page table-based techniques.

A hardware-based DRAM cache has an advantage of being capable of handling a cache miss while implementing a non-blocking design. However, it has scalability issues because metadata (e.g., tags) for a DRAM cache should be implemented in the on-package DRAM. In addition, the hardware-based techniques require a controller to translate between a physical memory address and a cache memory address, and thus there is a disadvantage of requiring additional memory bandwidth and power consumption.

On the other hand, page table-based techniques leverage a page table entry, a memory management unit (MMU), and a translation lookaside buffer (TLB), and therefore have an advantage of reduced hardware translation overhead and no additional overhead on DRAM cache hits. However, when a cache miss occurs, there is a problem of high overhead due to using a cache-miss controller of a software-implemented operating system.

Accordingly, there is a need in the art for a technique of implementing a DRAM cache that incorporates the advantages of both the hardware-based DRAM cache and the page table-based DRAM cache.

### SUMMARY

### Technical Problem

The present disclosure is directed to minimizing overhead associated with operation of a DRAM cache by managing metadata using a page table and handling a cache miss using hardware.

The problems to be solved by the present disclosure are not limited to those described above, and other problems explicitly not mentioned herein will be clearly understood by those skilled in the art from the following description.

### Technical Solution

As a DRAM cache management device according to an embodiment of the present disclosure, the DRAM cache management device may include: a processor; a main memory; a DRAM cache memory; a DRAM cache management unit connected to one or more cache frames that partition the DRAM cache memory; and a memory management unit configured to generate cache-miss information and transmit the generated cache-miss information to the DRAM cache management unit, wherein the DRAM cache management unit may be configured to receive the cache-miss information from the memory management unit, allocate a free cache frame from among the one or more cache frames upon receiving the cache-miss information, generate a data replication command, and update cache-main memory mapping information between the cache frames and one or more main memory frames that partition the main memory.

In addition, the transmission of the cache-miss information from the memory management unit to the DRAM cache management unit may offload handling of a cache miss to the DRAM cache management unit based on the generated cache-miss information.

In addition, the DRAM cache management unit may manage the one or more cache frames using a predetermined data structure.

In addition, the predetermined data structure may be a circular queue.

In addition, the DRAM cache management device may further include a DRAM cache-miss handling unit, and the DRAM cache management unit may transmit the generated data replication command to the DRAM cache-miss handling unit.

In addition, the transmission of the generated data replication command to the DRAM cache-miss handling unit may offload the data replication command to the DRAM cache-miss handling unit.

In addition, the processor may execute an eviction routine for releasing allocation of the one or more cache frames to generate a main memory update execution command, and transmit the generated main memory update execution command to the DRAM cache management unit.

In addition, the main memory update execution command may be based on information on one or more dirty pages included in an eviction-targeted page batch.

In addition, the information on the one or more dirty pages may include at least one of a number of dirty pages and dirty map information.

In addition, when a predetermined update command execution condition is satisfied during a caching phase of the DRAM cache memory, the DRAM cache management unit may execute the received main memory update execution command, and the predetermined update command execution condition may be that a caching-progress level of the DRAM cache memory is higher than an update progress level.

### Adventurous Effects

According to a DRAM cache management technique according to the present disclosure, it is possible to operate a DRAM cache with lower power consumption, reduced hardware modifications, and reduced overhead.

The effects according to the present disclosure are not limited to those described above, and other effects not explicitly mentioned herein will be clearly understood by those skilled in the art from the following description.

### BRIEF DESCRIPTION OF THE DRAWINGS

FIG. 1 is a block diagram illustrating part of a configuration of a DRAM cache management device according to some embodiments of the present disclosure.

FIG. 2 is a conceptual diagram illustrating a DRAM cache-miss handling flow of a DRAM cache management device according to some embodiments of the present disclosure.

FIG. 3 is a conceptual diagram illustrating a process in which a DRAM cache management device handles a cache miss according to some embodiments of the present disclosure.

FIG. 4 is a conceptual diagram illustrating a process in which a DRAM cache management device manages cache frames according to some embodiments of the present disclosure.

FIG. 5 is a block diagram illustrating configurations of a DRAM cache management unit and a DRAM cache-miss handling unit according to some embodiments of the present disclosure.

FIG. 6 is a flowchart illustrating a process of executing an eviction routine according to some embodiments of the present disclosure.

FIG. 7 is a conceptual diagram illustrating a process of updating a main memory for dirty pages according to some embodiments of the present disclosure.

FIG. 8 is a conceptual diagram illustrating a process of updating a main memory according to some embodiments of the present disclosure.

FIG. 9 is a graph illustrating a number of instructions per cycle (IPC) measured as a result of executing a workload according to a DRAM cache management method according to some embodiments of the present disclosure, compared with conventional methods.

FIG. 10 is a block diagram illustrating a DRAM cache management device according to the present disclosure.

### DETAILED DESCRIPTION OF THE EMBODIMENTS

Hereinafter, exemplary embodiments according to the present disclosure will be described in detail with reference to the content described in the attached drawings. However, the present disclosure is not restricted or limited by the exemplary embodiments. Unless otherwise defined, all terms (including technical and scientific terms) used herein are to be used with a meaning commonly understood by those having ordinary skill in the art to which this disclosure pertains, but this may vary depending on the intention of those skilled in the art, case law, or emergence of new technologies, etc.

In addition, terms defined in a commonly used dictionary are not to be interpreted ideally or excessively unless clearly and specifically defined otherwise. In a specific case, there are terms that the applicant has arbitrarily selected, and in this case, their meanings will be described in detail in the corresponding description part. Accordingly, the terms used in herein should be defined based on the meaning of the terms and the overall content of the present disclosure, rather than simply the names of the terms.

When it is said throughout this specification that a part “includes” a certain component, this does not exclude other components unless otherwise stated, but means other components may be further included. In addition, the singular forms used herein also include the plural forms unless specifically stated otherwise. In addition, the expression “at least one of a, b, and/or c” described throughout the present specification may encompass “a alone”, “b alone”, “c alone”, “a and b”, “a and c”, “b and c”, or “all of a, b, and c”.

Meanwhile, terms such as “first and/or second” used herein may be used to describe various components, but they are only used for the purpose of distinguishing one component from another component, and are not intended to be limited to the components referred to by the terms. For example, without departing from the scope of the present disclosure, the first component may be named as the second component, and the second component may also be named as the first component.

In addition, terms such as “ . . . unit”, “ . . . module”, etc. described herein mean a unit that processes at least one function or operation and may be implemented as hardware or software, or a combination of hardware and software. In addition, the embodiments of the present disclosure may be represented in terms of functional block configurations and various processing steps. Such functional blocks may be implemented as any number of hardware and/or software configurations that execute specific functions. For example, the embodiments of the present disclosure may employ direct circuit configurations such as memory, processing, logic, look-up table, etc., that may execute various functions under a control of one or more microprocessors or other control devices.

Similar to the components disclosed in the present specification being executable by software programming or software elements, the embodiments of the present disclosure includes various algorithms implemented as a combination of data structures, processes, routines, or other programming constructs, and may be implemented in a programming or scripting language such as C, C++, Java, assembler, etc. Functional aspects may be implemented as algorithms executed in one or more processors. In addition, the present embodiment may employ conventional technology for at least one of electronic environment setting, signal processing, and data processing. Terms such as “mechanism,” “element,” “means,” and “configuration” may be used broadly and are not limited to mechanical and physical configurations. The term may include a meaning of a series of software processes (routines) in connection with a processor, etc.

Each block of processing flow diagrams attached to the present specification and combinations of the flow diagrams may be performed by computer program instructions. These computer program instructions may be loaded on a processor of a general-purpose computer, a special-purpose computer, or other programmable data processing device, such that the instructions executed by the processor of the computer or other programmable data processing device create a means for executing the functions described in flowchart block(s).

These computer program instructions may be stored in a computer-usable or computer-readable memory that may direct the computer or other programmable data processing device to implement a function in a particular manner, and the instructions stored in the computer-usable or computer-readable memory may also produce a manufactured product that includes instruction means for executing the function described in the flowchart block(s).

Since computer program instructions may also be loaded onto a computer or other programmable data processing device, a series of operational steps may be performed on the computer or the other programmable data processing device to produce a computer-executed process, and accordingly, the instructions executed by the computer or the other programmable data processing device may also provide steps for performing functions described in a flowchart block(s).

In addition, each block may represent a module, segment, or part of a code that includes one or more executable instructions for executing a specified logical function(s). In addition, in some alternative execution examples, it may be possible for the functions mentioned in the blocks to occur out of order. For example, two consecutively illustrated blocks may in fact be executed substantially simultaneously, or the blocks may sometimes be executed in reverse order depending on their respective functions.

The “electronic device” or “terminal” referred to in the present specification may be implemented as a computer or portable terminal that can connect to a server or other terminal through a network. Here, the computer may include, for example, a notebook, desktop, laptop, etc. loaded with a web browser, and a portable terminal may include, for example, a wireless communication device that ensures portability and mobility, such as a communication-based terminal such as International Mobile Telecommunication (IMT), Code Division Multiple Access (CDMA), W-Code Division Multiple Access (W-CDMA), Long Term Evolution LTE), etc., and all kinds of handheld-based wireless communication devices such as a smartphone, tablet PC, etc. In addition, the “electronic device” or “terminal” referred to in the present specification may also include a processor, a memory for storing and executing program data, a permanent storage such as a disk drive, a communication port for communicating with an external device, a user interface device such as a touch panel, a key, a button, etc.

In the present disclosure, methods implemented as software modules or algorithms may be stored on a computer-readable recording medium as computer-readable codes or program instructions executable on a processor. Here, the computer-readable recording medium may include a magnetic storage medium (e.g., read-only memory (ROM), random-access memory (RAM), floppy disk, hard disk, etc.) and an optical reading medium (e.g., CD-ROM, DVD (Digital Versatile Disc)). The computer-readable recording medium may be distributed and executed across network-connected computer systems.

Hereinafter, various embodiments of the present disclosure will be described in detail with reference to the attached drawings. In describing the embodiments, a description of technical contents that are well known in the technical field to which the present disclosure pertains and are not directly related to the present disclosure will be omitted. This is to convey the gist of the present disclosure more clearly without obscuring the same by omitting unnecessary explanation. For the same reason, some components in the attached drawings are exaggerated, omitted, or schematically shown. In addition, size of each component does not entirely reflect its actual size. In the present specification, like reference numerals may refer to like or corresponding components throughout.

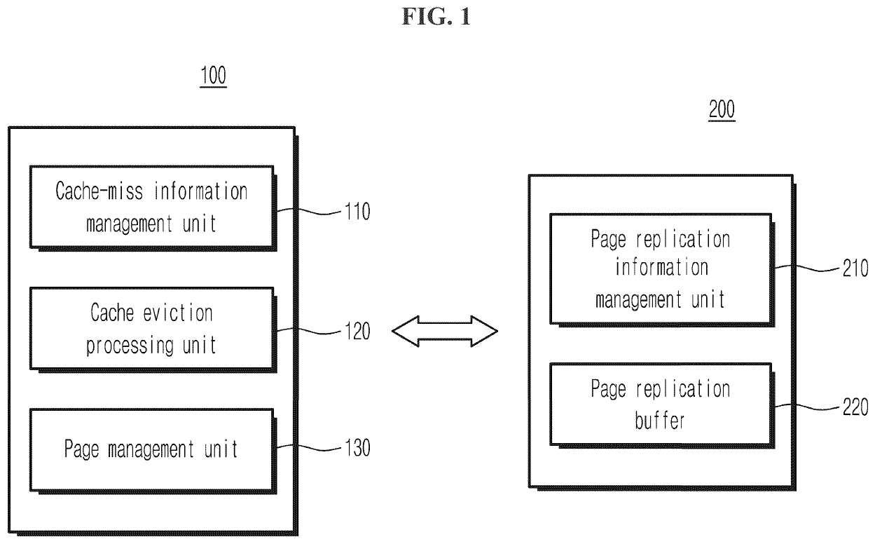

FIG. 1 is a block diagram illustrating part of a configuration of a DRAM cache management device according to some embodiments of the present disclosure.

Referring to FIG. 1, a DRAM cache management unit 100 according to some embodiments of the present disclosure may include a cache-miss information management unit 110, a cache eviction processing unit 120 and/or a page management unit 130.

In some embodiments, the cache-miss information management unit 110 may be implemented as a module in software, hardware and/or a combination thereof and is configured to handle a DRAM cache memory miss when such a miss occurs in a memory management unit (MMU) (not shown).

In some embodiments, the cache-miss information management unit 110 may allocate a free page, allocate a free cache frame, execute data replication from a main memory and/or an auxiliary memory to the DRAM cache, and/or execute mapping between the DRAM cache and the main memory. In one embodiment, the cache-miss information management unit 110 may transmit a command for offloading functions to one or more modules including data replication to the DRAM cache to an offload device, and receive a message indicating whether the offload operation is completed from the offload device.

Referring again to FIG. 1, the DRAM cache management unit 100 may include a cache eviction processing unit 120. In some embodiments of the present disclosure, the cache eviction processing unit 120 may be implemented as a module in software, hardware and/or a combination thereof and is configured to evict data and/or pages that are no longer to be stored in the cache memory.

In some embodiments, the cache eviction processing unit 120 may receive eviction information for executing an eviction operation, and may evict eviction-targeted data and/or pages from the DRAM cache based on the received eviction information.

In some embodiments, the cache eviction processing unit 120 may perform an operation to align the eviction-targeted data and/or pages with the main memory. The cache eviction processing unit 120 may also execute the eviction operation based on a predetermined criterion.

In some embodiments of the present disclosure, the DRAM cache management unit 100 may include a page management unit 130. In some embodiments, the page management unit 130 may be implemented as a module in hardware, software and/or a combination thereof, and is configured to manage a DRAM cache region on a per-page basis using a specific data structure.

In some embodiments, the page management unit 130 may use a circular queue structure to manage the DRAM cache region. In one embodiment, the rear of the circular queue may point to a first free page in the circular queue, while the front of the circular queue may point to a last page in a cache memory region. Accordingly, the remaining cacheable region may be calculated by the page management unit 130 based on a distance between the rear and front of the circular queue.

Referring to FIG. 1, the DRAM cache management device according to some embodiments of the present disclosure may include a DRAM cache-miss handling unit 200.

In some embodiments, the DRAM cache-miss handling unit 200 may be implemented as a module in hardware, software and/or a combination thereof, and is configured perform data processing in response to a DRAM cache-miss.

In some embodiments, the DRAM cache-miss handling unit 200 may receive a command from the DRAM cache management unit 100 or may perform the operations of the DRAM cache management device according to the present disclosure by transmitting the results of executing the command.

In some embodiments of the present disclosure, the DRAM cache-miss handling unit 200 may include a page replication information management unit 210. In some embodiments, the page replication information management unit 210 may be implemented as a module in hardware, software and/or a combination thereof, and is configured to manage information for replicating a required page into the DRAM cache memory based on a data and/or a page replication command received from the DRAM cache management unit 100.

In some embodiments, in order to manage the page replication information, the page replication information management unit 210 may manage data on the frame number in main memory of a replication-targeted page, a cache frame number where a replication occurs, and/or the progress of the page replication.

Referring to FIG. 1, the DRAM cache-miss handling unit 200 according to some embodiments of the present disclosure may include a page replication buffer 220. In some embodiments, the page replication buffer 220 may be configured as a buffer space for temporarily storing a page to be copied from the main memory. In one embodiment, when the DRAM cache-miss handling unit 200 loads data of a replication-targeted page from the main memory, the data may first be temporarily stored in the page replication buffer 220, and then copied into the cache memory.

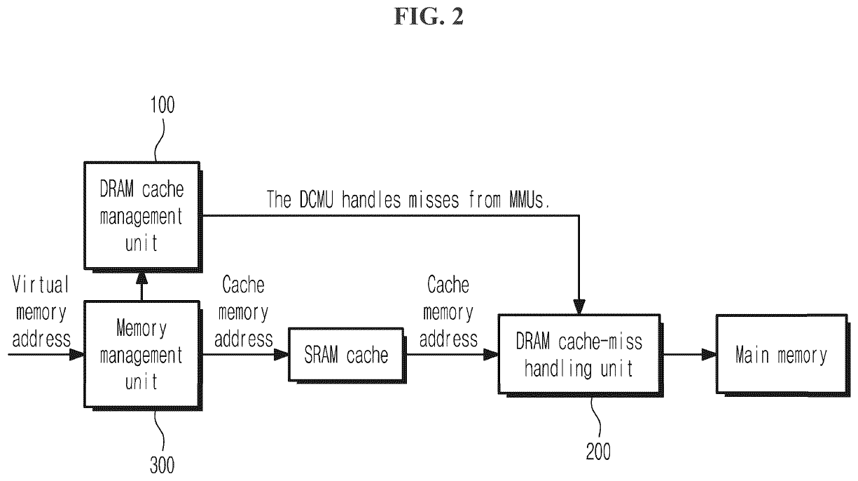

FIG. 2 is a conceptual diagram illustrating a DRAM cache-miss handling flow of a DRAM cache management device according to some embodiments of the present disclosure.

Referring to FIG. 2, in some embodiments of the present disclosure, a memory management unit (MMU) 300 may receive a virtual memory address requested by a process being executed. In some embodiments, the memory management unit may translate the virtual memory address into a cache memory address, and return the data included in the translated cache memory address to the executing process.

In some embodiments, when no data is present in the cache memory address translated from the virtual memory address, or when data that is not requested by the process is present (e.g., when a valid bit of a page frame table is 0), the memory management unit may generate a DRAM cache-miss signal.

In some embodiments of the present disclosure, when a DRAM cache-miss occurs, the memory management unit 300 may generate and transmit cache-miss information to the DRAM cache management unit 100. Preferably, the DRAM cache management unit 100 that receives the cache-miss information may be implemented as hardware. In some embodiments, in order to handle the cache-miss, the DRAM cache management unit 100 may return the address of a free cache frame to the memory management unit 300. In this case, the memory management unit 300 may update a page table entry and/or a translation lookaside buffer (TLB).

In some embodiments of the present disclosure, when a DRAM cache-miss occurs, the DRAM cache management unit 100 may offload copying a page requested by a process from the main memory to the DRAM cache memory, to the DRAM cache-miss handling unit 200. In this case, the DRAM cache-miss handling unit 200 may then copy the requested page from the main memory into the cache memory.

Although not shown in FIG. 2, in some embodiments, when a free page or a free cache frame available for allocation in the DRAM cache memory is insufficient, an interrupt to trigger execution of an eviction routine may be generated by the DRAM cache management unit 100.

An eviction routine (not shown), which may be implemented in software and/or hardware, may be executed in response to the interrupt generated by the DRAM cache management unit according to some embodiments of the present disclosure. The eviction routine may identify dirty pages from among pages that are to be evicted from the DRAM cache memory and transmit dirty page identification information and a command for performing an operation of ensuring data consistency between the DRAM cache and the main memory to the DRAM cache management unit.

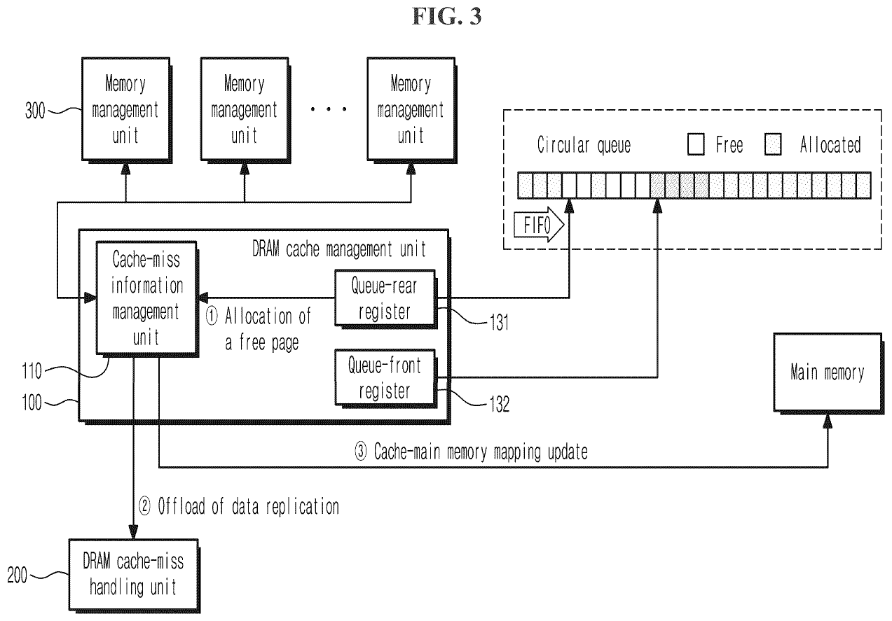

FIG. 3 is a conceptual diagram illustrating a process in which a DRAM cache management device handles a cache miss according to some embodiments of the present disclosure.

Referring to FIG. 3, upon receiving the cache-miss information from the memory management unit 300, the DRAM cache management device according to some embodiments of the present disclosure may allocate an allocatable free page using the cache-miss information management unit 110 and/or a queue-rear register 131.

In some embodiments, when the free page is allocated, the cache-miss information management unit 110 may offload data replication to the DRAM cache-miss handling unit 200 and handle the cache-miss by updating the cache-main memory mapping information.

In some embodiments, the DRAM cache management unit 100 may include one or more cache-miss information management units 110, and the DRAM cache-miss handling unit 200 may include one or more page replication information management units (not shown). Preferably, a number of the cache-miss information management units 110 may be identical to a number of the page replication information management units.

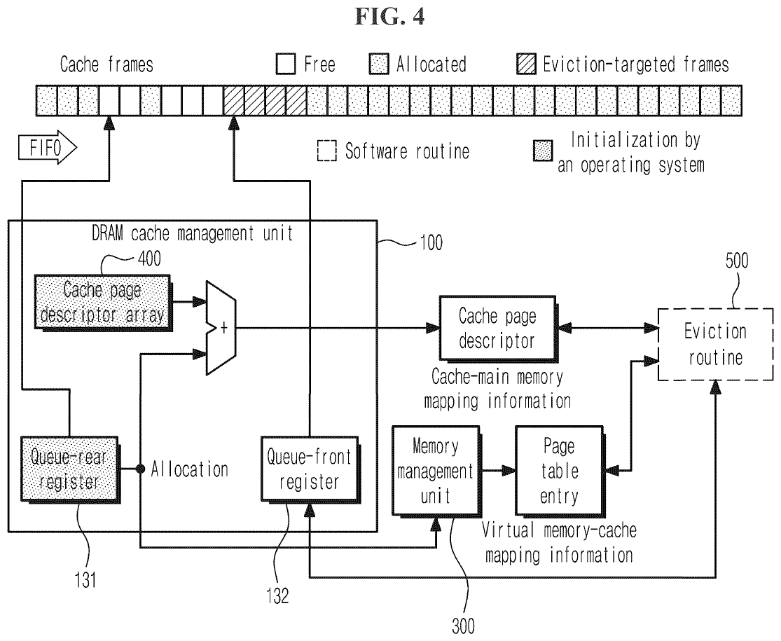

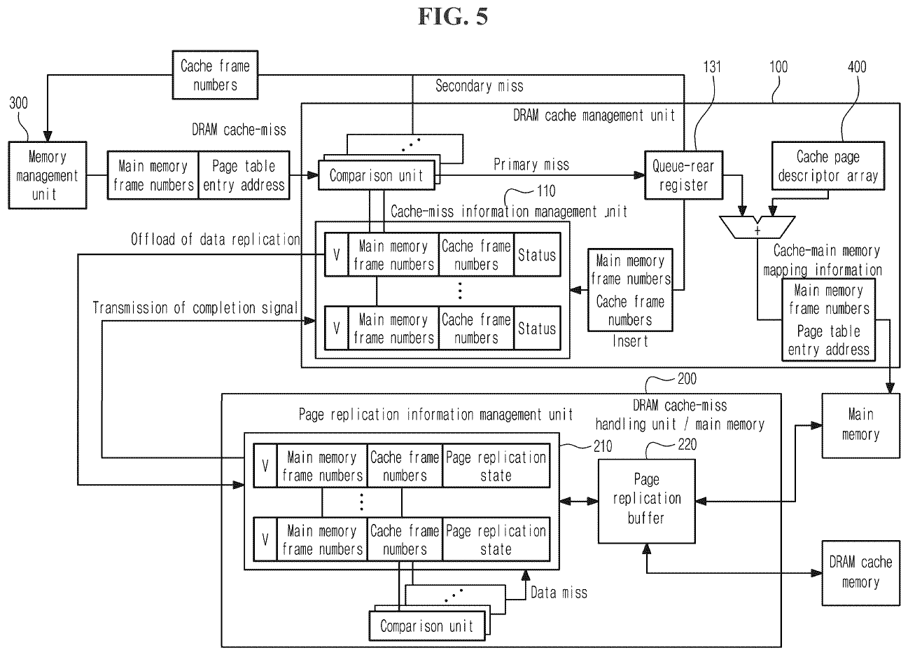

A detailed description regarding the cache-miss handling process will be provided below in FIG. 4 and FIG. 5.

FIG. 4 is a conceptual diagram illustrating a process in which a DRAM cache management device manages cache frames according to some embodiments of the present disclosure.

Referring to FIG. 4, the DRAM cache management unit 100 according to some embodiments of the present disclosure may manage information regarding a cacheable frame region using the queue-rear register 131 and a queue-front register 132. In this case, both the queue-rear register 131 and the queue-front register 132 may employ a circular structure to manage cache frames.

In some embodiments, as illustrated in FIG. 4, the queue-rear register 131 may point to the first frame among allocatable free cache frames, while the queue-front register 132 may point to the last frame of a cache region.

In some embodiments, when allocating a free cache frame, the DRAM cache management unit 100 may allocate the free cache frame indicated by the queue-rear register 131. In some embodiments, when the DRAM cache management unit 100 allocates a free cache frame, correspondence information between a free cache frame to be allocated and a main memory frame to be loaded into the free cache frame may be generated. For example, referring to FIG. 3, free cache frame information and corresponding main memory frame information may be stored in a cache page descriptor array 400.

In some embodiments, the DRAM cache management unit 100 may also measure a size of a cache region based on values of the queue-front register 132 and the queue-rear register 131. For example, the DRAM cache management unit 100 may calculate a distance between the front and rear of the queue for managing cache frames, and when the distance between the front and rear of the queue is smaller than a predetermined threshold, the DRAM cache management unit 100 may generate an interrupt to trigger execution of an eviction routine 500. In one embodiment, the eviction routine 500 may evict a cache frame from the front of the queue based on the cache-main memory mapping information that is based on the cache frame information and the main memory frame information stored in a cache page descriptor.

FIG. 5 is a block diagram illustrating configurations of a DRAM cache management unit and a DRAM cache-miss handling unit according to some embodiments of the present disclosure.

When implementing a non-blocking DRAM cache according to some embodiments of the present disclosure, two types of cache-misses may occur. In some embodiments, the first type of cache-miss is a primary cache-miss and may indicate that no data is present in a target cache line. In some embodiments, a cache controller allows the DRAM cache management unit 100 and/or the cache-miss information management unit 110 to handle the primary cache-miss.

The second type of cache-miss is a secondary cache-miss and may refer to a cache miss occurring in the same cache line while the primary cache-miss is being handled by the DRAM cache management unit 100 and/or the cache-miss information management unit 110. In some embodiments, to ensure data consistency and prevent duplicate memory processing, the secondary miss is handled by the primary cache-miss without allocating a new cache frame and/or page frame.

Referring to FIG. 5, when the memory management unit 300 according to some embodiments of the present disclosure detects a DRAM cache-miss and transmits cache-miss information to the DRAM cache management unit, the main memory frame number of the page in which the cache-miss occurred may be compared to the main memory frame numbers present in the cache-miss information management unit 110 by a comparison unit. For example, when the comparison unit determines that a frame in the cache-miss information management unit 110 matches the main memory frame number associated with the occurred cache-miss, the occurred cache-miss may be determined to be a secondary cache-miss. In some embodiments, in a case of a secondary cache-miss, the cache frame number allocated for the corresponding main memory frame may be transmitted to the memory management unit 300 without allocating a cache frame.

On the other hand, referring again to FIG. 5, in a case of a primary cache-miss, a cache frame indicated by the queue-rear register 131 may be newly allocated. In this case, the cache frame number of the newly allocated cache frame may be transmitted to the memory management unit 300 and address translation may resume. In addition, in one embodiment, the DRAM cache management unit 100 may cause the cache-miss information management unit 110 to handle the cache-miss and store the cache-main memory mapping information in the cache page descriptor.

Referring to FIG. 5, the DRAM cache management unit 100 may offload data replication for a cache miss to the DRAM cache-miss handling unit 200 located close to a memory controller. In some embodiments, page data in the main memory may be replicated in units of a burst size (e.g., sub block units) using the page replication buffer 220. In one embodiment, information regarding the replication state may be managed by the page replication information management unit 210.

In some embodiments, prior to accessing the DRAM cache, cache frame numbers for a memory request may be compared with the cache frame numbers managed by the page replication information management unit 210. In one embodiment, when a matching number between the cache frame numbers of the memory request and the cache frame numbers in the page replication information management unit 210 is present, it indicates that data replication from the main memory is still in progress, and accordingly the memory request may need to be held until the corresponding cache frame is fully replicated through the page replication buffer 220. In one embodiment, upon completion of the page replication, the DRAM cache-miss handling unit 200 may transmit completion information to the DRAM cache management unit 100, and accordingly, the DRAM cache management unit 100 may remove cache-miss information corresponding to the completion information.

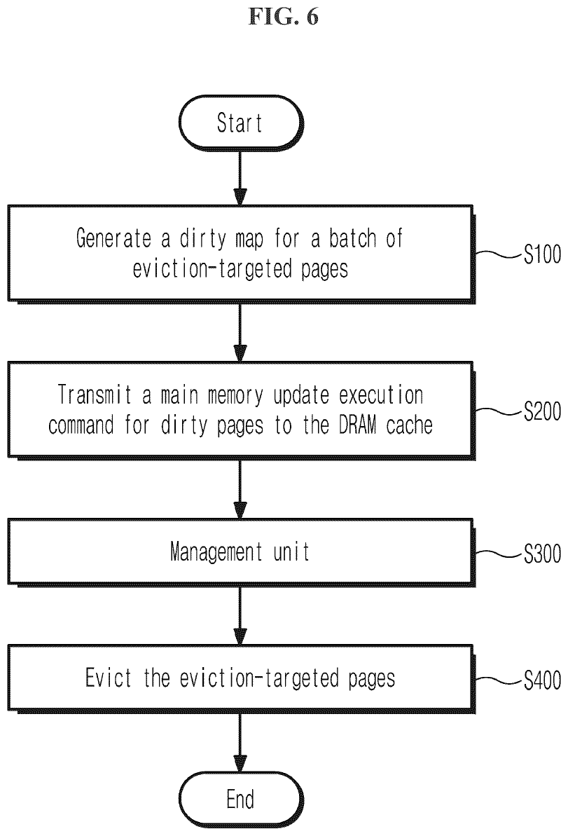

FIG. 6 is a flowchart illustrating a process of executing an eviction routine according to some embodiments of the present disclosure.

In the present disclosure, the DRAM cache management unit may generate an interrupt so that the processor executes a cache frame eviction routine when the distance between the rear and front of the circular queue is smaller than a predefined eviction threshold so as to execute an eviction routine.

Referring to FIG. 6, the eviction routine according to some embodiments of the present disclosure may include generating a dirty map for an eviction-targeted page batch (S100).

In one embodiment, in order to generate an eviction-targeted page and a dirty map, the processor executing the eviction routine may read cache page descriptor information and page table entry information of N pages (i.e., page batch), which is a predetermined number, from the front of the queue. In one embodiment, the processor may identify dirty pages from among the N pages using dirty bits included in the page table entry information. In one embodiment, the processor may read and reset the dirty bits of the dirty pages to 0.

In one embodiment, the processor executing the eviction routine may perform transmitting a main memory update execution command for the dirty pages to the DRAM cache management unit in order to ensure data consistency between the cache and main memory for the N page batches (S200). In one embodiment, the update of the main memory may be implemented using a writeback method. In order to perform the update of the main memory, the processor executing the eviction routine may transmit information regarding the batch size N, the number of dirty pages and/or the dirty map to the DRAM cache management unit.

In some embodiments, the processor executing the eviction routine may perform emptying the TLB (S300), and then perform evicting eviction-targeted pages (S400).

In some embodiments, since the replication of the dirty pages from among the eviction-targeted pages to the main memory is completed by the processor executing the eviction routine and the DRAM cache management unit, the processor executing the eviction routine may remove all of eviction-targeted pages as clean pages. Accordingly, the total execution time of an eviction routine may be reduced.

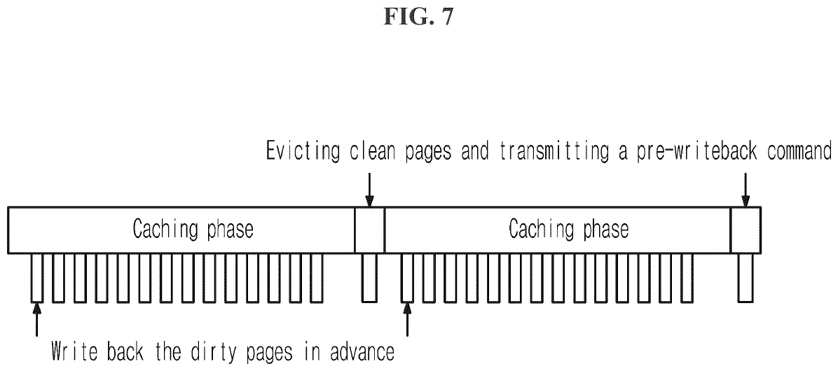

FIG. 7 is a conceptual diagram illustrating a process of updating a main memory for dirty pages according to some embodiments of the present disclosure.

Referring to FIG. 7, the DRAM cache management unit according to some embodiments of the present disclosure may update dirty pages in an eviction-targeted page batch to the main memory in order to ensure data consistency.

In some embodiments, the DRAM cache management unit may partition the dirty pages in the batch for updating during a caching phase (a phase in which eviction is not performed) rather than updating all of the dirty pages at once. Accordingly, since only clean pages are evicted during the eviction without updating the dirty pages, the execution time of the eviction may be significantly reduced. Accordingly, when a large number of dirty pages are present, the eviction may be prolonged, which may in turn prevent an application from being stalled.

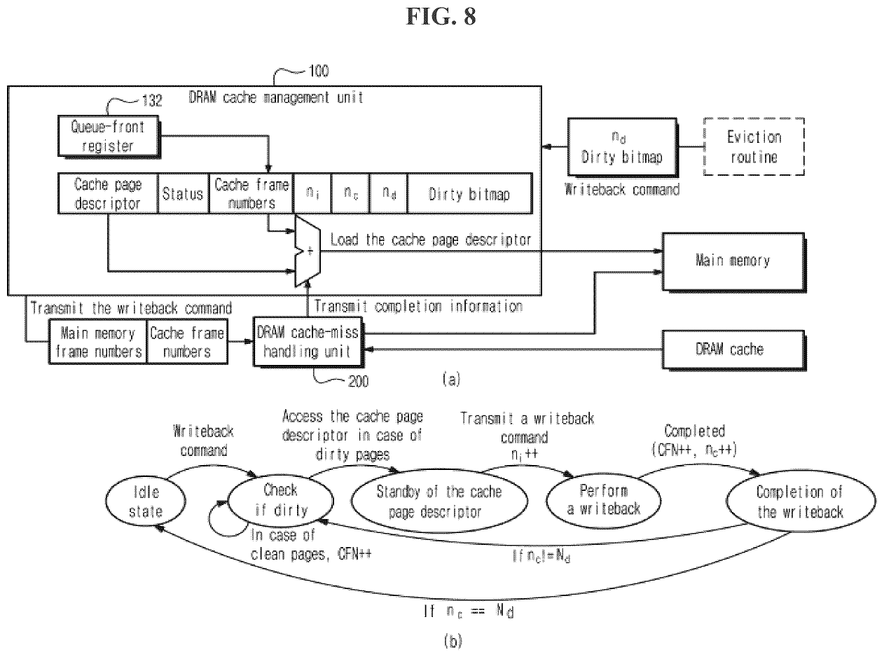

A process of updating the main memory for the dirty pages will be described in detail in FIG. 8.

FIG. 8 is a conceptual diagram illustrating a process of updating a main memory according to some embodiments of the present disclosure.

Referring to FIG. 8(a), the DRAM cache management unit 100 according to some embodiments of the present disclosure may receive an update request from the processor executing the eviction routine to replicate data present in the DRAM cache to the main memory. As described above, in some embodiments of the present disclosure, the update to the main memory may be performed using a writeback method. The updating process will be described below based on the writeback method. However, this description is provided merely as an example and should not be construed as limiting the methods for updating the main memory according to the present disclosure.

Referring to FIG. 8(a), the DRAM cache management unit 100 according to some embodiments of the present disclosure may receive a writeback command for dirty pages from the processor executing the eviction routine and perform a writeback of the dirty pages in the eviction-targeted page batch to the main memory during a caching phase. The DRAM cache management unit may include a finite state machine (FSM) for reading the cache page descriptor and transmitting a writeback request to the DRAM cache-miss handling unit 200, which will be described below.

Referring to FIG. 8(a), the DRAM cache management unit 100 according to some embodiments of the present disclosure may receive a writeback command from a processor executing the eviction routine while in an idle state. In one embodiment, upon receiving the writeback command, the DRAM cache management unit 100 may initialize registers for the cache frame numbers, the dirty bitmap, the number of dirty pages (N_{d}), and the number of pages cleaned in the batch (n_{c}), and/or the number of pages for which generation of the writeback command was completed (nᵢ), i.e., the number of pages for which the writeback command was received. The register for the cache frame numbers may be initialized to the front of the circular queue managing the cache frames, while the number of pages cleaned in the batch (n_{c}) and the number of pages for which the writeback command generation was completed (nᵢ) may be initialized to 0. In some embodiments, the dirty bitmap and the number of dirty pages may be initialized to values received from the processor executing the eviction routine.

Referring to FIG. 8(b), in some embodiments, the finite state machine of the DRAM cache management unit 100 may be provided to perform a pre-writeback according to the present disclosure. Referring to FIG. 8(b), for each eviction-targeted cache frame, the DRAM cache management unit may determine whether the frame is a dirty map with reference to the dirty map. For each determined dirty frame, the DRAM cache management unit may read a cache page descriptor of the respective dirty frame and then transmit a writeback request to the DRAM cache-miss handling unit 200 based on the read cache page descriptor.

In some embodiments, the DRAM cache management unit may return to the idle state after performing the processes illustrated in FIG. 8(b) for all dirty frames present in the eviction-targeted page batch.

As described above, the DRAM cache management unit according to some embodiments of the present disclosure may simultaneously perform cache frame allocation and a writeback during a caching phase. In some embodiments, the DRAM cache management unit may generate a writeback command only when a predetermined condition for executing the writeback command is satisfied. In one embodiment, the condition may be that a caching-progress level (P_{c}) is higher than an update-progress level (P_{w}). In another embodiment, the condition may be that the caching-progress level (P_{c}) is higher than a writeback-progress level (P_{w}) by a predetermined progress constant (α).

In some embodiments, the caching-progress level (P_{c}) and the writeback-progress level (P_{w}) may be calculated as follows.

$${P}_{c} = ( {D}_{r 2 f} - {T}_{e} ) / N \qquad [ Mathematical Equation 1 ]$$

$${P}_{w} = {n}_{i} / {N}_{d} \qquad [ Mathematical Equation 2 ]$$

$${D}_{r 2 f} : Distance from the front to rear of the queue$$

$${T}_{e} : Eviction distance$$

$$N : Eviction granularity$$

$${n}_{i} : The number of pages of which writeback command generation is$$

$${N}_{d} : The number of dirty pages$$

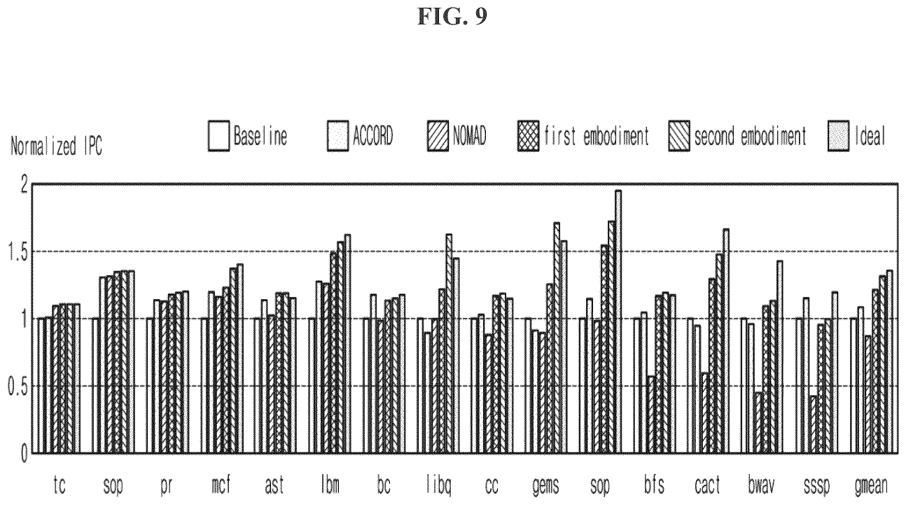

FIG. 9 is a graph illustrating a number of instructions per cycle (IPC) measured as a result of executing a workload according to a DRAM cache management method according to some embodiments of the present disclosure, compared with conventional methods.

Referring to FIG. 9, the DRAM cache management method according to the first embodiment of the present disclosure has exhibited a 40.2% performance improvement compared to the NOMAD technique among conventional DRAM cache management methods. The NOMAN technique illustrated in FIG. 9 is the DRAM cache management method disclosed in NOMAD: Enabling Non-blocking OS-managed DRAM Cache via Tag-Data Decoupling, Y. Kim et al, 2023. The first embodiment of the present disclosure may refer to an embodiment in which a cache miss is handled by the DRAM cache management unit and the DRAM cache-miss handling unit, while a conventional method is used for a writeback. Accordingly, when a cache miss is handled by hardware in the page table-based DRAM cache system described in the present disclosure, it was confirmed that a significant performance improvement was achieved.

Referring again to FIG. 9, the DRAM cache management method according to the second embodiment of the present disclosure exhibited an average performance improvement of 7.9% to 35% compared to the DRAM cache management method of the first embodiment. In this case, the DRAM cache management method according to the second embodiment of the present disclosure may be an embodiment in which eviction of a cache frame and a writeback are additionally performed using the pre-writeback technique described in the present disclosure in addition to the first embodiment. Accordingly, it may be confirmed that utilizing the pre-writeback technique described in the present disclosure may achieve a more significant performance improvement.

In addition, an experimental environment, benchmark and conventional DRAM cache management techniques used to obtain experimental results shown in FIG. 9 are described in Table 1 below.

TABLE 1

| | |
|---|---|
| Simulator | gem5 SE mode + DRAMsim3 |
| Benchmark | SPEC CPU@ 2006, GAPBS |
| Suites | Baseline (HBM-free system) ACCORD |
| | (hardware-based DRAM cache, a 64B line size) |
| | NOMAD (SOTA page table-based DRAM cache) |
| Memory | The first and second embodiments |
| Schemes | Ideal (Page table-based DRAM cache under the |
| | assumption that cache-miss handling and data |
| | replication overheads are absent) |

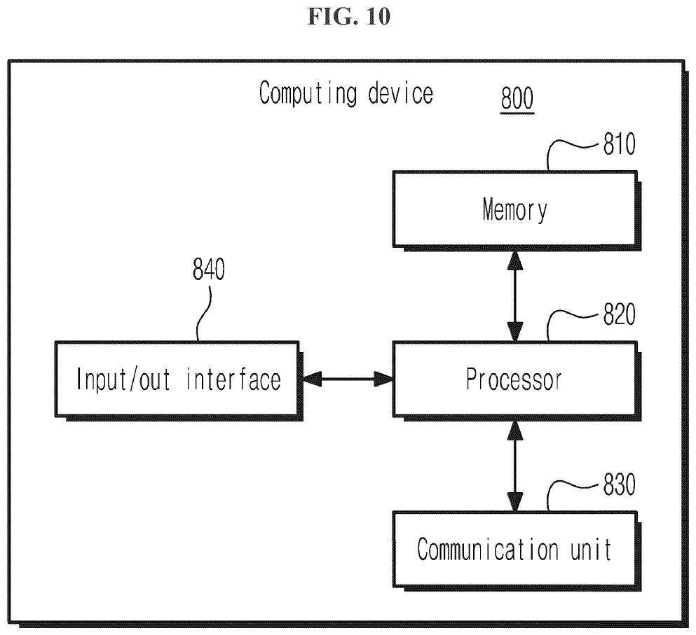

FIG. 10 is a block diagram illustrating a DRAM cache management device according to the present disclosure.

A computing device 800 may include a memory 810, a processor 820, communication unit 830 and an input/output interface 840, and as illustrated in FIG. 9, the computing device 800 may be configured to communicate information and/or data through a network using the communication unit 830.

The memory 810 may include a non-transitory computer readable medium. In one embodiment, the memory 810 may include a permanent mass storage device, such as a random access memory (RAM), a read only memory (ROM), a disk drive, a solid state drive (SSD), or a flash memory. As another example, a permanent mass storage device such as a ROM, SSD, flash memory, or disk drive may be included in the computing device 800 as a separate permanent storage unit other than the memory. In addition, an operating system and at least one program code may be stored in the memory 810.

These software components may be loaded from a computer readable medium that is separate from the memory 810. The separate computer readable medium may include a medium that may be directly connected to the computing device 800, for example, a computer readable medium such as a floppy drive, a disk, a tape, a DVD/CD-ROM drive, or a memory card. As another example, the software components may be loaded into the memory 810 through the communication unit 830, rather than from a computer readable medium. For example, at least one program may be loaded into the memory 810 based on a computer program installed using files provided through the communication unit 830 by developers or through a file distribution system that distributes application installation files.

The program may include a program instruction, a data file, and a data structure individually or in combination. The program may be designed and produced using a machine language code or a high-level language code. In particular, the program may be designed to embody the present disclosure described above, or may be implemented using any functions or definitions already known to those skilled in the art of computer software. The program that embodies the present disclosure described above may be recorded on a medium readable by the processor.

The memory may store a program that performs the above-described operations as well as operations described below, and the processor may execute the program stored in the memory. When the processor and memory are plural, the processors and memories may be integrated on a single chip or provided at physically separate locations. The memory may include a volatile memory, such as a static random access memory (S-RAM) or a dynamic random access memory (D-RAM) for temporarily storing data. The memory may also include a non-volatile memory, such as a read only memory (ROM), an erasable programmable read only memory (EPROM), or an electrically erasable programmable read only memory (EEPROM), for storing a control program and control data over an extended period of time.

The processor 820 may be configured to process instructions from a computer program by performing basic calculations, logic operations, and input/output operations. The instructions may be transmitted to other user terminals (not shown) or to other external systems by the memory 810 or the communication unit 830.

The processor may include various logic circuits or operational circuits, process data based on the program provided from the memory, and generate a control signal according to the results of such processing. In this case, the processor and the memory may be implemented as separate chips, respectively. In addition, the processor and the memory may be implemented as a single chip.

The processor 820 may include one or more processors. The one or more processors may be homogeneous or heterogenous processors. For example, the processor 820 may include heterogenous processors, such as a central processing unit (CPU), a graphics processing unit (GPU), and a tensor processing unit (TPU), and/or neural processing unit (NPU). For convenience of description, one or more homogenous or heterogenous processors may be collectively referred to herein as a “processor.”

The communication unit 830 may provide a configuration or functionality for communication between a user terminal (not shown) and the computing device 800 through a network, and may also provide a configuration or functionality for the computing device 800 to communicate with an external system (e.g., a separate cloud system). As an example, a control signal, an instruction, and data, etc. that are provided according to the control of the processor 820 of the computing device 800 may pass through a communication unit of a user terminal and/or external system through the communication unit 830 and a network, and ultimately be transmitted to the user terminal and/or the external system.

A wired communication unit may include various cable communication units, such as a universal serial bus (USB), a high definition multimedia interface (HDMI), a digital visual interface (DVI), a recommended standard 232 (RS-232), a power line communication, or a plain old telephone service (POTS), as well as various wired communication units, such as a local area network (LAN) module, a wide area network (WAN) module, or a value added network (VAN) module.

A wireless communication unit may include not only a Wi-Fi module and a wireless broadband module, but also various wireless communication units that support different wireless communication methods, such as a global system for mobile communication (GSM), a code division multiple access (CDMA), a wideband code division multiple access (WCDMA), a universal mobile telecommunication system (UMTS), a time division multiple access (TDMA), long term evolution (LTE), 4G, 5G, or 6G.

The wireless communication unit may include a wireless communication interface including an antenna and a transmitter for transmitting a Wi-Fi signal. In addition, the wireless communication unit may further include a Wi-Fi signal conversion module that modulates a digital control signal output from a control unit through the wireless communication interface, into an analog wireless signal under the control of the control unit.

The wireless communication unit may include a wireless communication interface including an antenna and a receiver for receiving a Wi-Fi signal. In addition, the wireless communication unit may further include a Wi-Fi signal conversion module that demodulates an analog wireless signal received through the wireless communication interface into a digital control signal.

A short-range communication unit for short range communication may support short range communication using at least one of Bluetooth, radio frequency identification (RFID), infrared data association (IrDA), ultra wideband (UWB), ZigBee, near field communication (NFC), Wi-Fi, Wi-Fi direct, or wireless USB.

The input/output interface 840 of the computing device 800 may be a means for interfacing with an input or output unit (not shown) that is included in or connected to the computing device 800.

The input unit is configured to receive information and data including audio information (or signals) and text from a network or a user and may include at least one of a microphone and a user input device. The data collected by the input unit may be analyzed and processed as a user control command.

The user input device is configured to receive information from a user, and when information is received from the user input device, the control unit may control operations of the computing device in accordance with the received information. Such a user input device may include a hardware physical key (e.g., a button located on at least one of the front, rear or side of the computing device, a dome switch, a jog wheel, or a jog switch) and a software touch key. As an example, the software touch key may be a virtual key, soft key, or visual key that is displayed on a touchscreen-type display through software processing, or a touch key provided on a display other than the touchscreen. Meanwhile, the virtual key or the visual key may be displayed on the touchscreen in various forms, for example, graphic, text, icon, video or a combination thereof.

Although FIG. 10 illustrates the input/output interface 840 as a component separately configured from the processor 820, the input/output interface 840 is not limited thereto and may be configured to be integrated with the processor 820. The computing device 800 may include components in addition to those illustrated in FIG. 10. However, it is not necessary to explicitly illustrate all conventional components.

The processor 820 of the computing device 800 may be configured to manage, process and/or store information and/or data received from a plurality of user terminals and/or a plurality of external systems.

The above-described method and/or various embodiments may be implemented in a digital electronic circuit, computer hardware, firmware, software and/or combinations thereof. Various embodiments of the present disclosure may be executed by a data processing device, for example, one or more programmable processors and/or one or more computing devices, or implemented as a computer-readable recording medium and/or a computer program stored in the computer-readable recording medium. The above-described computer program may be written in any programming language, including compiled or interpreted languages, and may be distributed in any form, such as a standalone program, module, subroutine, etc. The computer program may be distributed across a single computing device, across a plurality of computing devices connected through the same network, and/or across a plurality of computing devices connected through a plurality of different networks.

The above-described method and/or various embodiments may be performed by one or more processors configured to execute one or more computer programs that process, store and/or manage any functionalities, functions, etc. by operating on raw samples or generating output data. For example, the method and/or various embodiments of the present disclosure may be performed by a special purpose logic circuit such as a field programmable gate array (FPGA) or an application specific integrated circuit (ASIC), and a device and/or system for performing the method and/or embodiments of the present disclosure may be implemented as the special purpose logic circuit such as the FPGA or the ASIC.

One or more processors executing the computer program may include a general purpose or special purpose microprocessor and/or one or more processors of any type of a digital computing device. The processor may receive instructions and/or data from each of the read-only memory and the random access memory, or may receive instructions and/or data from both the read-only memory and the random access memory. In the present disclosure, components of the computing device performing the method and/or embodiments may include one or more processors for executing the instructions, and one or more memory devices for storing the instructions and/or data.

According to one embodiment, the computing device may exchange data with one or more mass storage devices for storing data. For example, the computing device may receive data from a magnetic disc or an optical disc, and/or transfer data to a magnetic disc or an optical disc. A computer-readable storage medium suitable for storing instructions and/or data associated with the computer program may include any form of non-volatile memory including a semiconductor memory device such as erasable programmable read-only memory (EPROM), electrically erasable PROM (EEPROM), flash memory device, etc., but it is not limited thereto. For example, the computer-readable storage medium may include a magnetic disk such as an internal hard disk or a removable disk, a magneto-optical disk, a CD-ROM, and a DVD-ROM disk.

In order to provide interaction with a user, the computing device may include a display device (e.g., a cathode ray tube (CRT), a liquid crystal display (LCD), etc.) for providing or displaying information to the user, and a pointing device (e.g., a keyboard, a mouse, a trackball, etc.) for enabling the user to provide input and/or command, etc. to the computing device, but it is not limited thereto. That is, the computing device may further include any other types of devices for providing interaction with the user. For example, the computing device may provide any form of sensory feedback to the user including visual feedback, auditory feedback, and/or tactile feedback, etc., for interaction with the user. In this regard, the user may provide input to the computing device through various gestures such as visual, vocal, and motion, etc.

In the present disclosure, various embodiments may be implemented in a computing system including a backend component (e.g., a data server), a middleware component (e.g., an application server) and/or a front-end component. In this case, the components may be interconnected by any form or medium of digital data communication, such as a communication network. For example, the communication network may include a local area network (LAN), a wide area network (WAN), etc.

The computing device based on exemplary embodiments described in the present specification may be implemented using hardware and/or software configured to interact with a user by including a user device, a user interface (UI) device, a user terminal, or a client device. For example, the computing device may include a portable computing device such as a laptop computer. Additionally or alternatively, the computing device may include personal digital assistants (PDAs), tablet PCs, game consoles, wearable devices, internet of things (IoT) devices, virtual reality (VR) devices, augmented reality (AR) devices, etc., but it is not limited thereto. The computing device may further include other types of devices configured to interact with a user. In addition, the computing device may include a portable communication device (e.g., a mobile phone, a smart phone, a wireless cellular phone, etc.) suitable for wireless communication over a network such as a mobile communication network, etc. The computing device may be configured to communicate wirelessly with a network server using wireless communication technologies and/or protocols, such as radio frequency (RF), microwave frequency (MWF), and/or infrared ray frequency (IRF).

In an embodiment according to the present disclosure, functionalities related to artificial intelligence may be implemented through a processor and memory. In this case, the processor may be any one of a general-purpose processor such as a center processing unit CPU), an application processor (AP), a digital signal processor (DSP), a graphics-only processor such as a graphics processing unit (GPU), a vision processing unit (VPU), and an artificial intelligence-only processor such as an neural network processing unit (NPU). The processor may process raw samples according to a predefined operating rule or artificial intelligence model stored in the memory. In addition, when the processor is a dedicated AI processor, the dedicated AI processor may be designed with a hardware structure specialized for processing a specific AI model. In some embodiments according to the present disclosure, functionalities related to artificial intelligence may be implemented through a plurality of processors.

The above-described contents are specific embodiments for practicing the present disclosure. The present disclosure will include not only the above-described embodiments, but also embodiments that are simply designed or can be easily changed. In addition, the present disclosure will also include techniques that can be easily modified and implemented using the above-described embodiments. Therefore, the scope of the present disclosure should not be limited to the above-described embodiments, but should be defined not only by the claims described below but also by equivalents of the claims of the present disclosure.

What is claimed is:

1. A DRAM cache management device, comprising:
a processor;
a main memory;
a DRAM cache memory;
a DRAM cache management unit connected to one or more cache frames that partition the DRAM cache memory; and
a memory management unit configured to generate cache-miss information and transmit the generated cache-miss information to the DRAM cache management unit,
wherein the DRAM cache management unit is configured to:
receive the cache-miss information from the memory management unit;
allocate a free cache frame from among the one or more cache frames upon receiving the cache-miss information;
generate a data replication command; and
update cache-main memory mapping information between the cache frames and one or more main memory frames that partition the main memory.

2. The DRAM cache management device of claim 1, wherein the transmission of the cache-miss information from the memory management unit to the DRAM cache management unit offloads handling of a cache miss to the DRAM cache management unit based on the generated cache-miss information.

3. The DRAM cache management device of claim 1, wherein the DRAM cache management unit manages the one or more cache frames using a predetermined data structure.

4. The DRAM cache management device of claim 3, wherein the predetermined data structure is a circular queue.

5. The DRAM cache management device of claim 1, further comprising a DRAM cache-miss handling unit,
wherein the DRAM cache management unit transmits the generated data replication command to the DRAM cache-miss handling unit.

6. The DRAM cache management device of claim 5, wherein the transmission of the generated data replication command to the DRAM cache-miss handling unit offloads the data replication command to the DRAM cache-miss handling unit.

7. The DRAM cache management device of claim 1, wherein the processor executes an eviction routine for releasing allocation of the one or more cache frames to generate a main memory update execution command, and
transmits the generated main memory update execution command to the DRAM cache management unit.

8. The DRAM cache management device of claim 7, wherein the main memory update execution command is based on information on one or more dirty pages included in an eviction-targeted page batch.

9. The DRAM cache management device of claim 8, wherein the information on the one or more dirty pages includes at least one of a number of dirty pages and dirty map information.

10. The DRAM cache management device of claim 7, wherein, when a predetermined update command execution condition is satisfied during a caching phase of the DRAM cache memory, the DRAM cache management unit executes the received main memory update execution command, and
the predetermined update command execution condition is that a caching-progress level of the DRAM cache memory is higher than an update progress level.
